(19) United States
(12) Patent Application Publication
(10) Pub. No.: US 2010/0290826 A1
(43) Pub. Date: Nov. 18, 2010

(54) PAPER BINDING APPARATUS, PAPER BINDING METHOD, AND IMAGE FORMING APPARATUS

(75) Inventors: Takahiro KAWAGUCHI, Shizuoka (JP); Isao YAHATA, Shizuoka (JP); Hiroyuki TAGUCHI, Shizuoka (JP); Ken IGUCHI, Shizuoka (JP); Hiroyuki TSUCHIHASHI, Shizuoka (JP); Hiroyuki TAKI, Shizuoka (JP)

Correspondence Address: PATTERSON & SHERIDAN, L.L.P., 3040 POST OAK BOULEVARD, SUITE 1500, HOUSTON, TX, 77056, US

(73) Assignees: KABUSHIKI KAISHA TOSHIBA, Tokyo (JP); TOSHIBA TEC KABUSHIKI KAISHA, Tokyo (JP)

(21) Appl. No.: 12/779,654

(22) Filed: May 13, 2010

Related U.S. Application Data
(60) Provisional application No. 61/178,387, filed on May 14, 2009.
(60) Provisional application No. 61/178,438, filed on May 14, 2009.
(60) Provisional application No. 61/178,440, filed on May 14, 2009.
(60) Provisional application No. 61/178,444, filed on May 14, 2009.
(60) Provisional application No. 61/178,445, filed on May 14, 2009.
(60) Provisional application No. 61/218,811, filed on Jun. 19, 2009.
(60) Provisional application No. 61/218,839, filed on Jun. 19, 2009.

(51) Int. Cl. G03G 15/00; B42C 9/00

(52) U.S. Cl. 399/408; 412/37; 412/8

(57) ABSTRACT

A paper binding apparatus includes: a paper carrying unit which carries papers so as to be sequentially stacked on a tray; a binding sheet supply unit which attaches a binding sheet applied with pseudo-adhesive to a lower surface of one end of the paper first stacked on the tray in the carriage direction so as to protrude in a pectinate shape; a binding sheet attaching unit which sequentially bends a plurality of protruding pieces of the binding sheet so as to be pressed against an upper surface of one end of the carried paper whenever a new paper is carried to the tray; and a discharge unit which discharges a bundle of papers bound by the binding sheet.

### CROSS-REFERENCE TO RELATED APPLICATION

This application is based upon and claims the priority of

U.S. Provisional Application No. 61/178,387, filed on May, 14, 2009,
U.S. Provisional Application No. 61/178,438, filed on May, 14, 2009,
U.S. Provisional Application No. 61/178,440, filed on May, 14, 2009,
U.S. Provisional Application No. 61/178,444, filed on May, 14, 2009,
U.S. Provisional Application No. 61/178,445, filed on May, 14, 2009,
U.S. Provisional Application No. 61/218,811, filed on Jun. 19, 2009,
U.S. Provisional Application No. 61/218,839, filed on Jun. 19, 2009, the entire contents of which are incorporated herein by reference.

### TECHNICAL FIELD

The embodiments described herein relates to a paper binding apparatus performing a binding process on a paper discharged from, for example, an image forming apparatus, a paper binding method, and an image forming apparatus.

### BACKGROUND

In recent years, an image forming apparatus (for example, MFP) includes a paper post-processing apparatus which is adjacent to the rear end of the MFP so as to perform post-processing on a paper having an image formed thereon. The paper post-processing apparatus is called a finisher. The finisher staples or punches holes in the paper sent from the MFP, and discharges the paper from an outlet to a storage tray.

However, since the paper is stapled or punched, the paper has a scratch, and the paper cannot be reused in a printing apparatus. In addition, when a bundle of papers is bound, since the bundle is unfolded and seen about a binding member, a bending line is formed on the paper, therefore more difficult to use the paper again.

### DESCRIPTION OF THE DRAWINGS

FIG. 1 is a configuration diagram of a main body of an image forming apparatus and a finisher according to an embodiment.

FIG. 2 is a basic configuration diagram of a binding unit inside the finisher when seen from the front side thereof.

FIGS. 3A and 3B are configuration diagrams of the binding unit when seen in a direction depicted by the arrow A of FIG. 2.

FIG. 4 is a perspective view showing a configuration of a holder storing the binding sheet.

FIG. 5 is a sectional view showing a configuration of the holder.

FIG. 6 is a perspective view showing a state where a binding sheet is attached to a bottom surface of a paper.

FIGS. 7A and 7B are perspective views showing an operation of bending the binding sheet through a pressure roller.

FIG. 8 is a perspective view showing a state where the binding sheet is bent when seen in another direction.

FIGS. 9A to 9E are perspective views serially showing the operation of bending the binding sheet.

FIG. 10 is a perspective view showing a bundle of papers bound by the binding sheet.

FIG. 11 is a perspective view showing a state where a bundle of papers is unfolded.

FIGS. 12A and 12B are perspective views showing another operation of bending the binding sheet through the pressure roller.

FIG. 13 is a perspective view showing a state where a bundle of papers of FIG. 12B is unfolded.

FIGS. 14A and 14B are perspective views showing a modified example of the binding sheet.

FIG. 15 is a perspective view showing another modified example of the binding sheet.

FIGS. 16A to 16C are perspective views showing a state where adhesive is attached to the binding sheet.

FIG. 17 is a perspective view showing still another modified example of the binding sheet.

FIG. 18 is a block, diagram showing a control system of the finisher and the image forming apparatus.

FIG. 19 is a configuration diagram showing a modified example of the finisher.

FIG. 20 is a perspective view showing a state where the binding sheet is attached to the bottom surface of the paper.

FIG. 21 is a perspective view showing a bound bundle of papers.

FIG. 22 is a perspective view showing another embodiment of the binding unit

FIG. 23 perspective view showing an operation of binding a paper through the binding-sheet.

FIG. 24 is a perspective view showing an operation of welding the binding sheet through a thermal head.

FIG. 25 is a perspective view showing an operation of gutting the binding sheet through the thermal head.

### DETAILED DESCRIPTION

A paper binding apparatus of an embodiment includes a paper carrying unit which carries papers so as to be sequentially stacked on a tray; a binding sheet supply unit which attaches a binding sheet applied with pseudo-adhesive to the lower surface of one end of the paper first stacked on the tray in the carriage direction so as to protrude in a pectinate shape; a binding sheet attaching unit which sequentially bends a plurality of protruding pieces of the binding sheet so as to press the upper surface of one end of the transported paper whenever a new paper is carried onto the tray; and a discharge unit which discharges a bundle of papers bound by the binding sheet.

Hereinafter, the paper binding apparatus and the image forming apparatus according to the embodiment will be described in detail with reference to the drawings. The same reference numerals are given to the same constituents in the respective drawings.

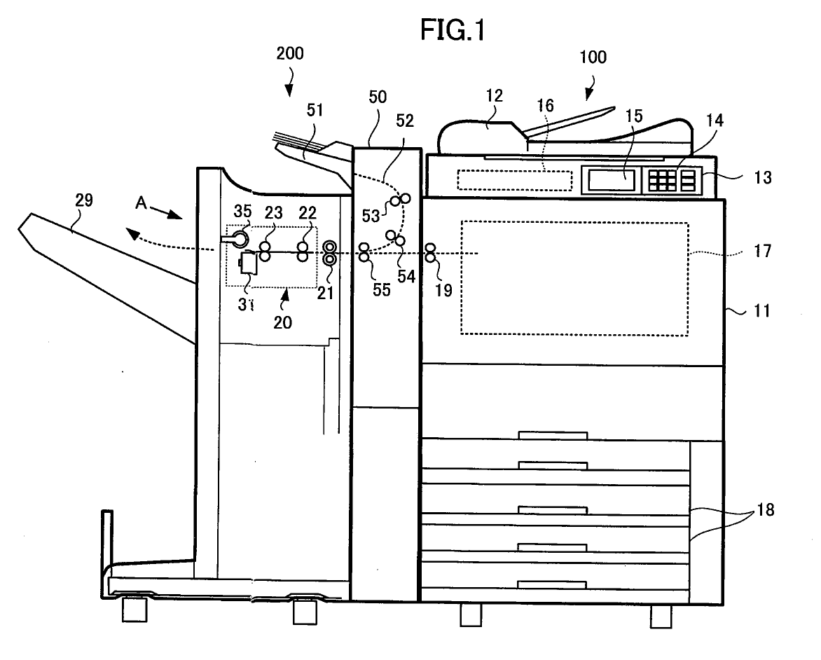

FIG. 1 is a configuration diagram showing the image forming apparatus including a paper post-processing apparatus. In FIG. 1, reference numeral 100 denotes the image forming apparatus, for example, an MFP (Multi-Functional Peripherals) as a multi-functional apparatus, a printer, a copier, or the like. A paper post-processing apparatus 200 is disposed to be adjacent to the image forming apparatus 100. The paper having an image formed thereon by the image forming apparatus 100 is carried to the paper post-processing apparatus 200.

The paper post-processing apparatus 200 includes a binding unit which binds multiple sheets of papers supplied from the image forming apparatus 100. The paper post-processing apparatus 200 will be described hereinafter as a finisher 200.

In FIG. 1, the upper portion of a body 11 of the image forming apparatus 100 is provided with a document table, and an automatic document feeder (ADF) 12 is provided on the document table so as to be freely openable or closeable. The upper portion of the body 11 is provided with an operational panel (operation unit) 13. The operational panel 13 includes an operation section 14 having various types of keys and a touch panel type display 15.

Inside the body 11 are included a scanner unit 16 and a printer unit 17, and the root portion of the body 11 is provided with a plurality of cassettes 18 storing various sizes of papers. The scanner unit 16 is configured to read an original document fed by the ADF 12 or an original document placed on the document table.

The printer unit 17 includes a photoconductive drum, laser, and the like, and is configured to perform scanning exposure on the surface of the photoconductive drum through a laser beam from the laser and to create an electrostatic latent image on the photoconductive drum. A charger, a developer, a transcriber, and the like are disposed in the periphery of the photoconductive drum. The electrostatic latent image of the photoconductive drum is developed by the developer, and a toner image is formed on the photoconductive drum. The toner image is transferred to the paper through the transcriber. The configuration of the printer unit 17 is not limited to the above-described example, but the printer unit 17 may be configured in various types.

The paper S having an image formed thereon by the body 11 is carried to the finisher 200. The finisher 200 includes a binding unit 20 which binds a bundle of papers. The finisher 200 functions as a paper binding apparatus, and discharges the bound papers to a storage tray 29.

The binding unit 20 receives the paper S, supplied through a carriage roller 19 of the image forming apparatus 100, through an entrance roller 21 of the binding unit 20. Carriage rollers 22 and 23 are provided on the downstream side of the entrance roller 21, and carry the paper S in a direction toward the storage tray 29.

The finisher 200 may include an inserter 50. The inserter 50 is disposed between the image forming apparatus 100 and the binding unit 20, and sequentially feeds the paper having an image formed thereon to the finisher 200. The inserter 50 includes a paper feeding tray 51, a carriage path 52 which carries the papers stored in the paper feeding tray 51 to the binding unit 20, and carriage rollers 53 and 54.

In addition, a carriage roller 55 is provided in the path from the image forming apparatus 100 to the entrance roller 21 of the binding unit 20. The paper S discharged from the image forming apparatus 100 is sent to the binding unit 20 through the carriage rollers 19 and 55. The paper carried by the carriage rollers 53 and 54 of the inserter 40 is sent to the binding unit 20 through the carriage roller 55.

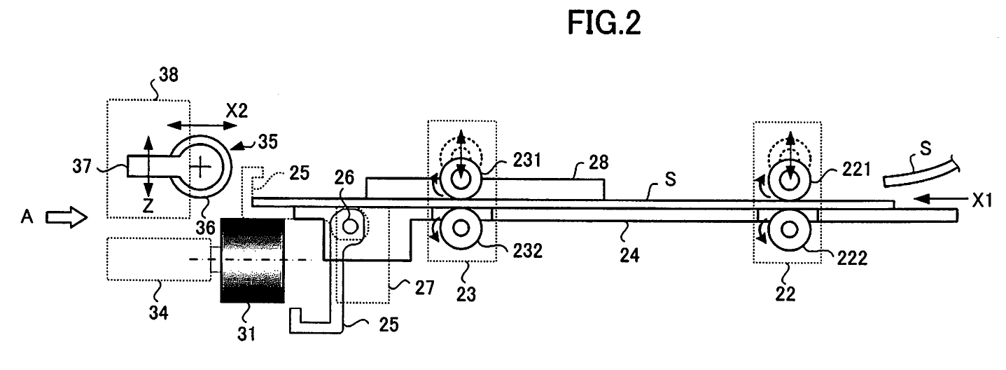

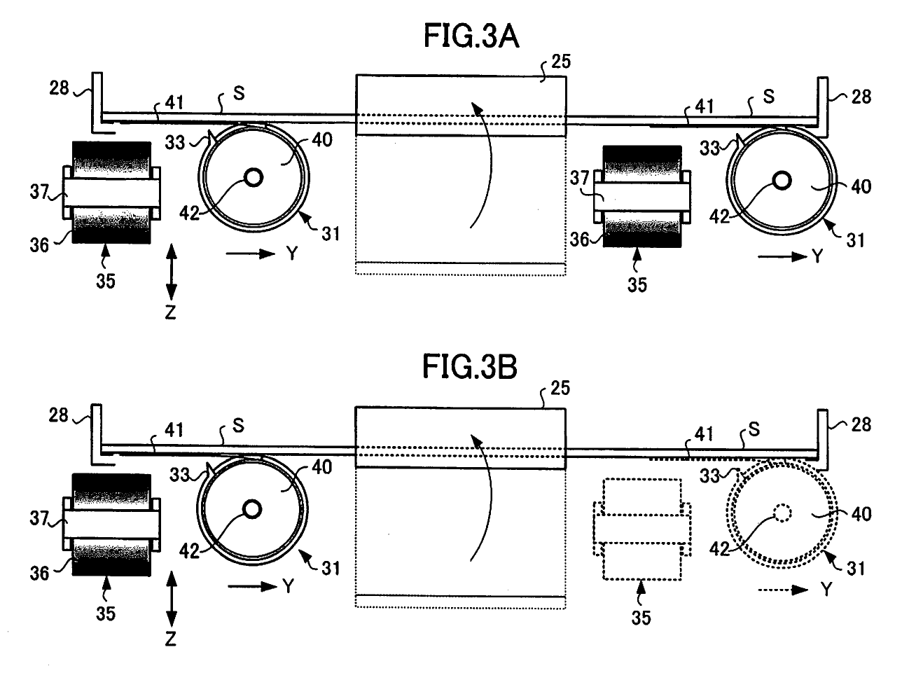

FIG. 2 is a basic configuration diagram of the binding unit 20 inside the finisher 200 when seen from the front side thereof. FIG. 3A is a configuration diagram showing the binding unit 20 when seen in a direction depicted by the arrow A of FIGS. 1 and 2. The binding unit 20 binds a bundle of papers by using a resinous film applied with pseudo-adhesive in advance and having flexibility or a paper sheet (hereinafter, referred to as a binding sheet). When the resinous film is used for the binding sheet, polyethylene, polyester, polypropylene, or the like may be used. When the paper sheet is used for the binding sheet, a paper and the like as a pulp material having a thickness of 80 μm or less may be used.

In FIGS. 2 and 3A, the binding unit 20 includes the carriage rollers 22 and 23 which carry the paper S, and carries the paper while being placed on the tray 24. The paper carriage direction is depicted by the arrow X1 of FIG. 2. A stopper 25 is provided on the downstream of the paper carriage direction of the tray 24. The stopper 25 is rotatable about a support point 26, and includes a rotation mechanism 27 which controls the rotation of the stopper 25.

When the papers S are not bound, the stopper 25 is located on the lower side, and sequentially passes and discharges the carried papers S to the storage tray 29. In addition, when a plurality of papers S is bound, the stopper 25 is rotated to the upper side so as to protrude to the paper carriage path, receives, and stops the carried papers using the stopper 25, and then sequentially stacks the plurality of papers S on the tray 24.

After the binding is completed, the stopper 25 is rotated to the lower side, and a bundle of bound papers is discharged to the storage tray 29 by the rotation of the carriage rollers 22 and 23. Accordingly, the carriage rollers 22 and 23 serve as a paper carrier unit and a paper discharger unit.

The carriage roller 22 includes an upper roller 221 and a lower roller 222, and the carriage roller 23 also includes an upper roller 231 and a lower roller 232. The paper S is carried while being pinched between the rollers 221 and 222 and between the rollers 231 and 232. The upper rollers 221 and 231 are movable in the vertical direction, and move upward as the amount of the papers S stacked on the tray 24 increases. However, the upper rollers 221 and 231 are normally urged toward the tray 24 side so as to press down the papers S. In addition, transverse alignment plates 28 are provided on both sides of the tray 24 in the carriage direction so as to align the carried paper S in the transverse direction.

The binding unit 20 is used to bend a part of the binding sheet and to attach the binding sheet to the front end of the sequentially carried paper. The downstream side of the tray 24 is provided with a holder 31 which stores the sheet roll winding the binding sheet and a pressure roller 35 which bends and presses the binding sheet. A part of FIG. 3A is shown as a sectional view so as to show the internal structure of the holder 31.

The holder 31 is movable in a direction (Y direction) perpendicular to the carriage direction X1 along the front end of the paper S and a direction (Z direction) coming into contact with the paper S and moving away from the paper S, and is provided with a movement mechanism 34 (FIG. 2) which controls the movement of the holder 31.

The pressure roller 35 includes a roller 36 and an arm 37 which supports the roller 36. The pressure roller 35 is movable in the vertical direction (Z direction), and in the reverse direction (X2 direction) of the carriage direction X1 of the paper S. Also, the pressure roller 35 can move stepwise in the Y direction. A movement mechanism 38 is provided so as to control the movement of the pressure roller 35. The movement mechanism 38 controls the movement of the pressure roller 35 by supporting the arm 37.

FIG. 3A shows, an example in which a pair of holders 31 and pressure rollers 35 is provided, and two positions of the front end of the paper S are bound.

In addition as shown in FIG. 3B, one holder 31 and one pressure roller 35 may be provided so as to be moved to a plurality of binding positions (for example, two positions) in the Y direction along the front end of the paper S, and to bind the front end of the paper S. In the example of FIG. 3B, the movement ranges of the holder 31 and the pressure roller 35 are wide, although takes some time for the binding process, the number of constituent parts is small.

Hereinafter, the binding process of the papers will be described in detail.

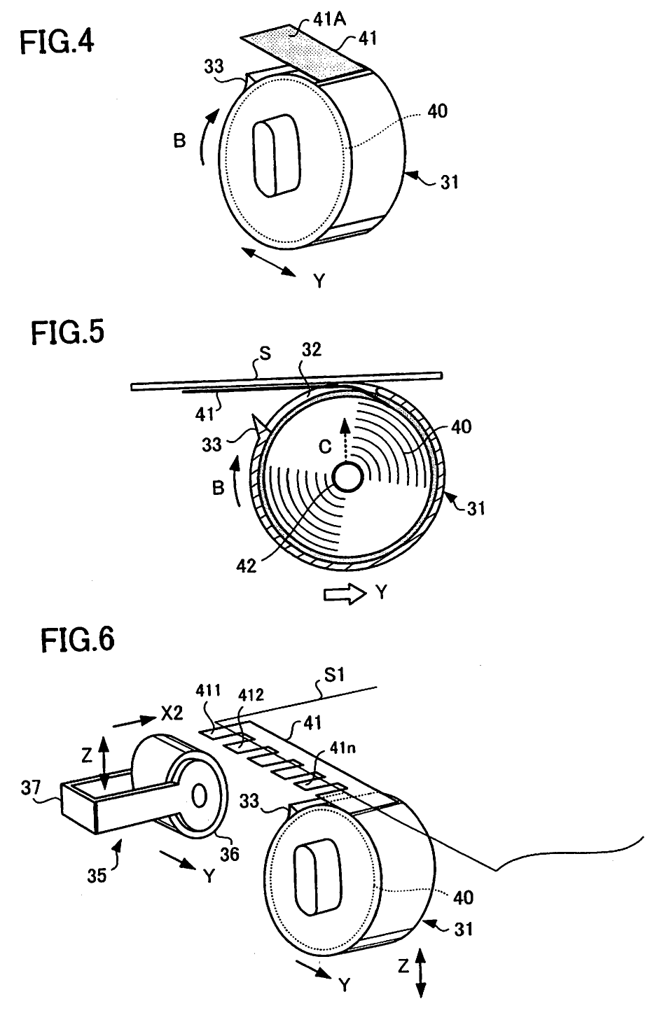

FIG. 4 is a perspective view showing a configuration of the holder 31, and FIG. 5 is a sectional view of the holder 31. The holder 31 includes a sheet roll 40 which is obtained by winding the binding sheet 41 around the rotation shaft 42 in a roll shape. The sheet roll 40 is stored in the holder 31 having a cylindrical section. The rotation shaft 42 is rotatably attached to the holder 31, and the binding sheet 41 is extracted from an outlet 32 provided in the holder 31.

The rotation shaft 42 is urged in a direction (a direction depicted by the arrow C of FIG. 5) toward the outlet 32 so as to be supported in the inside of the holder 31, and the end of the binding sheet 41 is normally located on the side of the outlet 32 even when the diameter of the sheet roll 40 becomes small.

In addition, adhesive 41A is applied on the outer peripheral surface of the binding sheet 41. The adhesive 41A has adhesion strength in which the adhesive is easily separated, and is called pseudo-adhesive. The binding sheet 41 may be attached to the paper S by the pseudo-adhesive, or may be separated from the paper S.

As shown in FIG. 5, the holder 31 is movable in a direction (Y direction) perpendicular to the carriage direction X1 along the front end of the paper S, and attaches the binding sheet 41 to the bottom surface (lower surface) of the front end of the lowermost paper S when a bundle of papers is bound. In addition, a cutter 33 is provided in the outer periphery of the holder 31, and the binding sheet 41 may be cut at an arbitrary position when the holder 31 is rotated in a direction (a direction depicted by the arrow B) close to the paper S. Since the cutter 33 cuts the binding sheet 41 at the position where the binding sheet 41 slightly protrudes from the outlet 32, the end of the binding sheet 41 normally protrudes from the outlet 32.

In addition, the cutter 33 is provided separately from the holder 31, and the cutter 33 may be controlled separately so as to cut the binding sheet 41. Further, the sheet roll 40 may be directly used without being stored in the holder 31. When the holder 31 is not used, the position of the sheet roll 40 is controlled by the movement mechanism 34.

As shown in FIG. 5, when the holder 31 moves in the Y direction while the binding sheet 41 is attached to the bottom surface of the paper S, the sheet roll 40 rotates together with the shaft 42, so that the binding sheet 41 is extracted from the holder 31 and is attached to the paper S. If the holder 31 rotates in the B direction when the binding sheet 41 is extracted by a predetermined length, the binding sheet 41 is cut by the cutter 33. The holder 31 reversely rotates until the original state after the cutting is reached. The holder 31 is separated from the paper S after attaching the binding sheet 41 to the paper S. The holder 31 and the movement mechanism 34 constitute a binding sheet supply unit.

FIG. 6 shows a state where the binding sheet 41 is attached to the bottom surface (lower surface) of the front end of the paper S1. In addition, the paper S1 is depicted to be transparent for the description of the shape of the binding sheet 41. The binding sheet 41 is formed in a pectinate shape. The body of the binding sheet 41 is attached to the bottom surface of the paper S1, and the pectinate-shaped protrusions 411, 412, 413, . . . 41n protrude from the front end of the paper S. In the following description, the protrusions are simply referred to as teeth 411, 412, 413, . . . 41n.

The arm 37 of the pressure roller 35 is movable in the vertical direction (Z direction), and in the reverse direction (X2 direction) of the carriage direction X1 of the paper S. In addition, the arm 37 is movable in a stepwise manner in the Y direction. The stepwise movement is performed in accordance with the interval of the teeth 411, 412, 413, . . . 41n of the binding sheet 41.

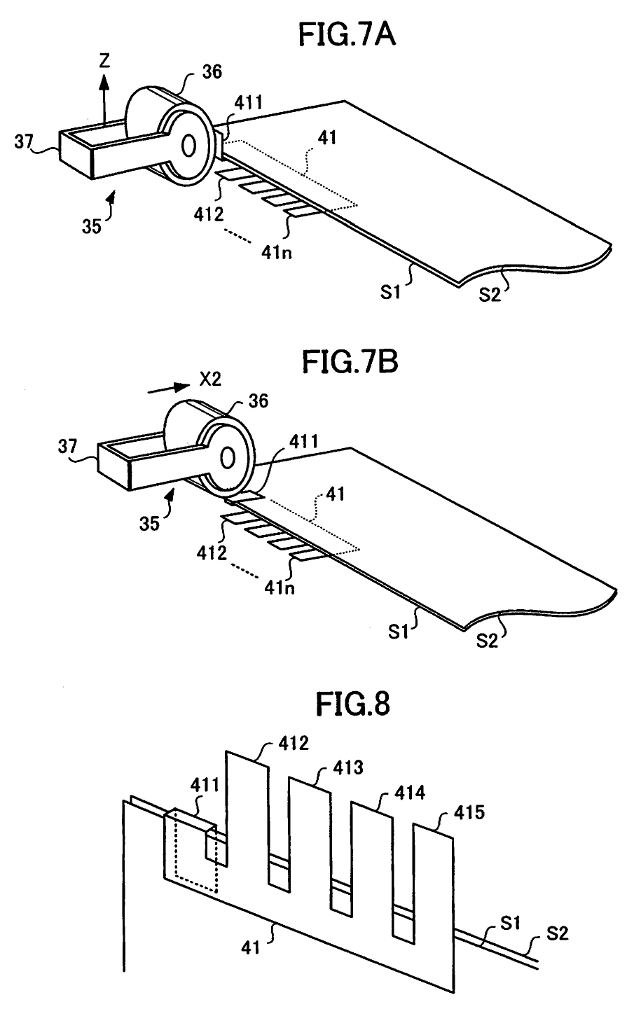

The pressure roller 35 is located at the root portion of the front end of the paper S1 at the initial position. After the binding sheet 41 is attached to the initial paper S, when the subsequent paper S2 is carried, the pressure roller 35 moves upward in the upward direction as shown in FIG. 7A so as to bend the tooth 411 of the binding sheet 41. After the tooth 411 is bent, the pressure roller 35 moves in the X2 direction as shown in FIG. 7B so as to further bend the tooth 411 in the X2 direction, and to press and attach the tooth 411 to the upper surface of the second paper S2. FIG. 8 shows the binding sheet 41 when seen from the bottom surface of the paper S1, and shows a state where the tooth 411 is attached to the upper surface of the second paper S2. The pressure roller 35 and the movement mechanism 38 constitute a binding sheet attaching unit.

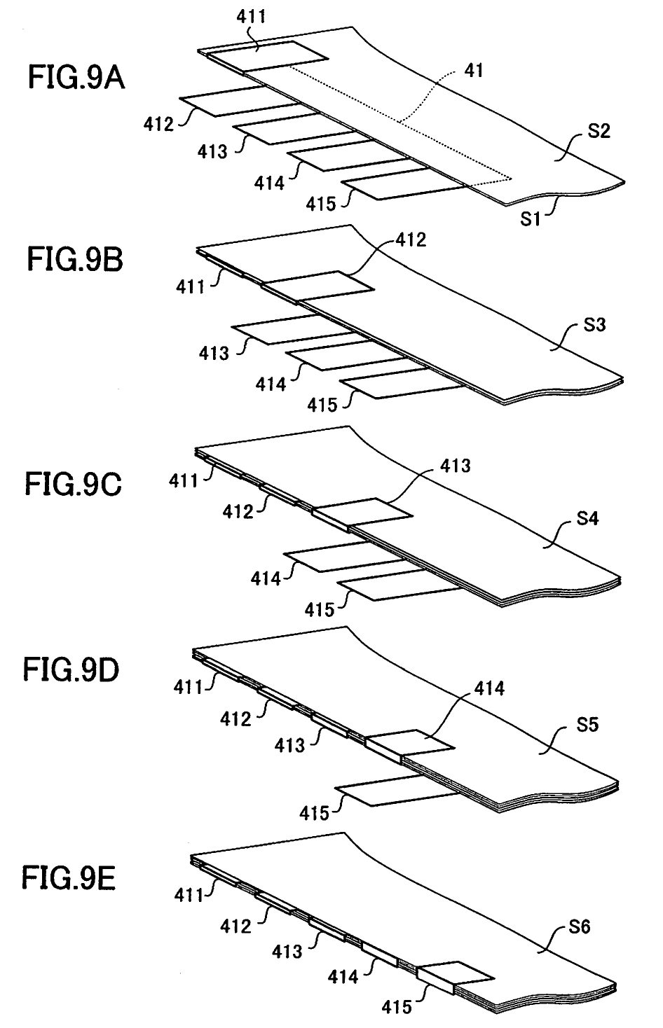

FIG. 9A shows a state where the tooth 411 is bent and attached to the second paper S2, and FIG. 9B shows a state where the next tooth 412 is bent and attached to the third paper S3. Hereinafter, in the same manner, as shown in FIGS. 9C to 9E, the teeth 413 to 415 are attached to the upper surfaces of the sequentially carried papers S3 to S6, thereby binding multiple sheets of papers. Since the binding sheet 41 is formed in a pectinate shape, the teeth 411 to 41n are easily bent and pressed.

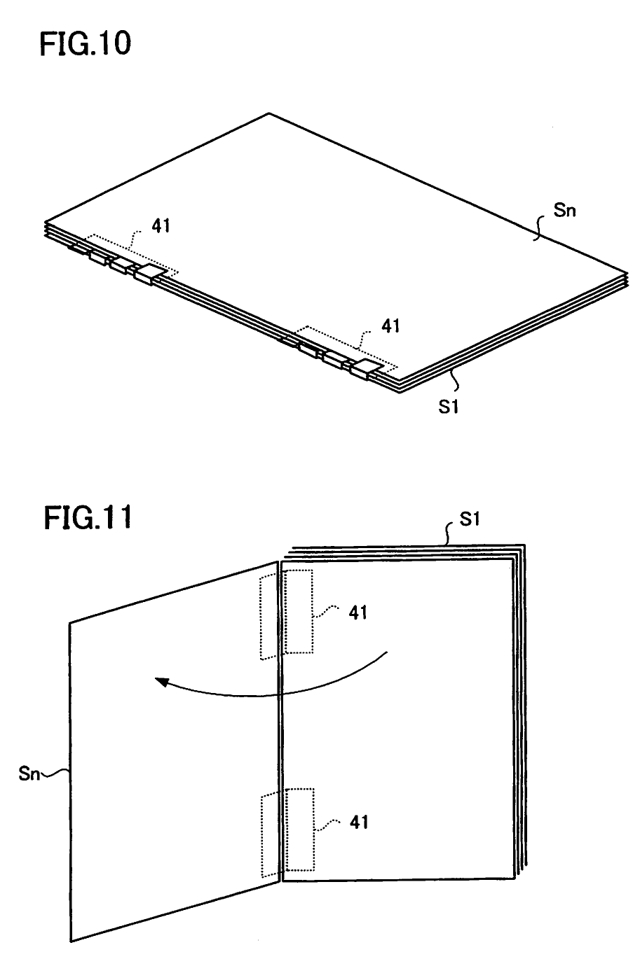

FIG. 10 shows a state where the binding sheet, 41 is attached to two positions of the front end of a bundle of papers and the papers are bound. FIG. 11 shows a state where a bundle of bound papers is unfolded about the binding sheet 41. Each paper may be easily unfolded without being bent. The unfolding angle may be close to 360°.

After a bundle of papers is bound by the binding sheet 41 and a part or a body of the binding sheet 41 is stretched, the binding sheet 41 can be continuously separated without damaging the papers. Accordingly, the bundle of papers can be separated.

Further, the position of cutting the binding sheet 41 must be changed in accordance with the number of papers constituting the bundle of papers. As understood from FIGS. 9A to 9E, when the number of papers is m, the cutting position may be a position where the number of teeth of the binding sheet 41 is n (n=m−1).

A user may operate, for example, the operational unit 13 of the image forming apparatus 100 so as to input the number of papers. Alternatively, the number of papers may be checked when the number of papers is input upon inserting the papers to the inserter 50.

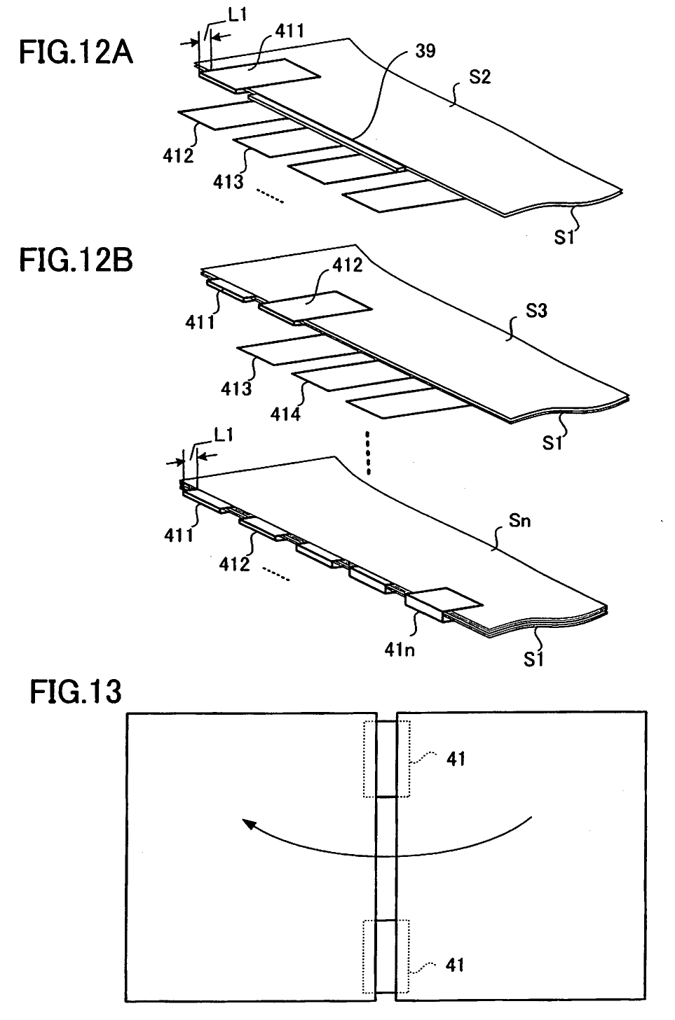

FIG. 12A shows an example in which a space L1 is provided between the front end of the paper S and the bent portion of the binding sheet 41 from refining a method of bending the binding sheet 41. When a squared member 39 formed of, for example, a material to which pseudo-adhesive is hardly attached is inserted into the front end of the paper S upon bending the binding sheet 41, the space L1 can be provided.

FIG. 12B shows an example in which the square member 39 is omitted for convenience of description, and the teeth 412, 413, 414, and 41n of the binding sheet 41 are sequentially bent.

FIG. 13 shows a state where two positions of a bundle of papers are bound through the binding method of FIG. 12A and FIG. 12B, and the bundle of papers is unfolded about the binding sheet 41. The unfolding of binding sheet 41 can be performed to an angle close to 360°.

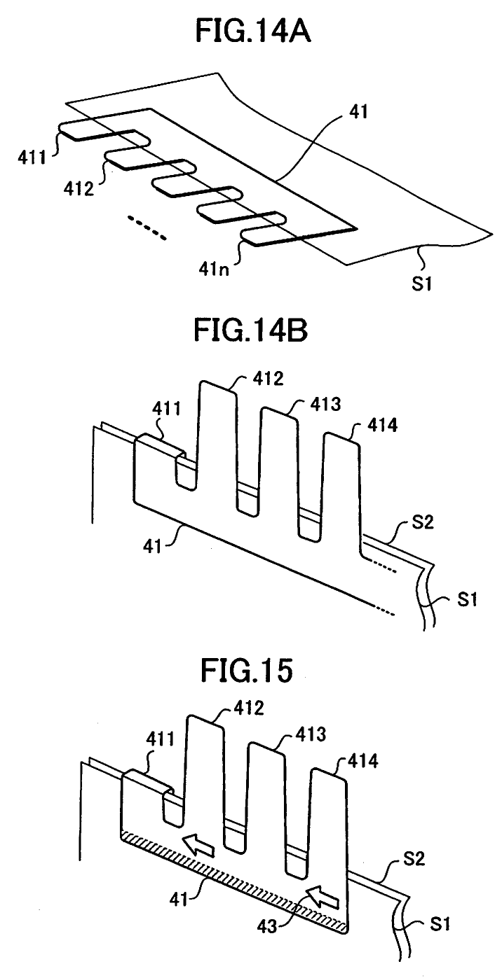

FIGS. 14A and 14B are perspective views showing a modified example of the binding sheet 41. In FIG. 14A, the root portions of the teeth 411 to 41n of the binding sheet 41 are round. That is, by having a curve surface (R), possible to prevent the teeth 411 to 41n from being cut upon separating the binding sheet 41. FIG. 14B shows a state where the tooth 411 is bent and attached to the upper surface of second paper S2.

FIG. 15 is a perspective view showing another modified example of the binding sheet 41. The binding sheet 41 of FIG. 15 is an example in which pseudo-adhesive is not applied to the end of the body of the binding sheet 41 (oblique line portion) upon being attached to the bottom surface of the first paper S1 so that the binding sheet 41 is easily separated by the user. In addition, a mark 43 such as an arrow may be printed on the binding sheet 41 so as to indicate the separation direction. When the separation direction is marked, easy to separate the binding sheet 41.

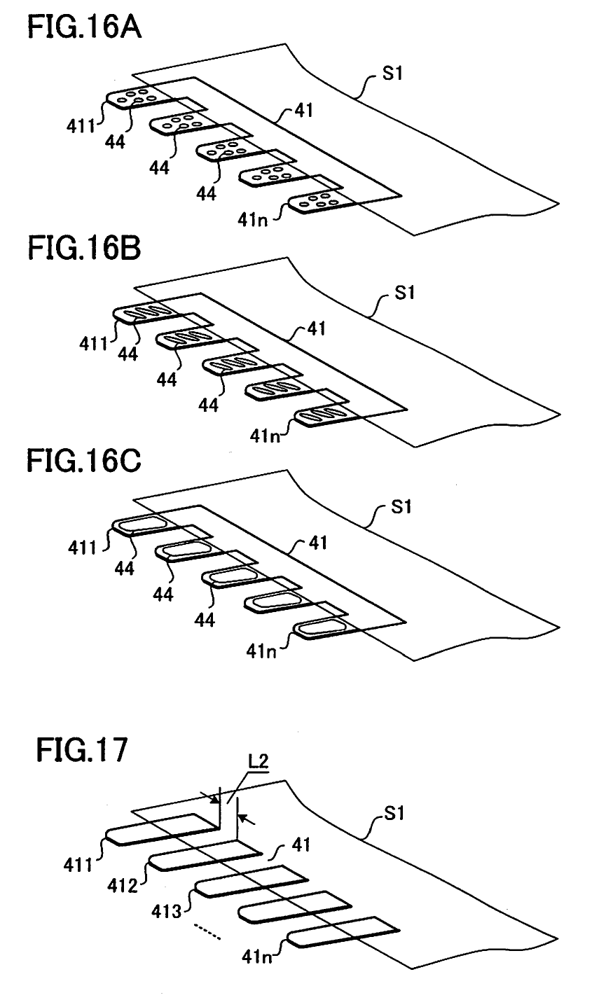

FIGS. 16A to 16C are diagrams showing still another modified example of the binding sheet 41.

FIG. 16A shows an example in which the pseudo-adhesive 44 is applied to each of teeth 411 to 41n in a dot shape. FIG. 16B shows an example in which the pseudo-adhesive 44 is applied to each of teeth 411 to 41n, in a line shape. FIG. 16C shows an example in which the pseudo-adhesive 44 is applied only to the inner portion of each of the teeth 411 to 41n, and is not applied to the peripheral portion thereof.

In FIGS. 16A to 16C, since there is provided a non-application area of the pseudo-adhesive 44, possible to adjust the application amount, to reduce the usage amount of the adhesive, to ensure adhesiveness between the paper S and the binding sheet 41, and to easily separate the binding sheet 41.

FIG. 17 is a diagram showing still another modified example of the binding sheet 41. FIG. 17 shows an example in which each of the teeth 411 to 41n is separated, and the binding sheet 41 is sequentially cut and attached to the bottom surface of the first paper. S1 with an interval L2 therebetween. Since the attachment positions of the binding sheets 411 to 41n are sequentially deviated from each other, only a part of the bound bundle cannot be thickened by the binding sheet 41. In addition, the binding sheets 411 to 41n may be separated one by one upon separating the bundle of papers.

In the above-described embodiment, a plurality of papers can be bound as a bundle without damaging the front surface, the rear surface, or the end of the paper S. In addition, each of the papers can be easily unfolded without bending. Further, after the bundle is formed by the binding sheet 41, and a part or a body of the binding sheet 41 is stretched, possible to continuously separate the papers without damaging the papers, and thus to separate the bundle of papers. Accordingly, since the quality of the paper is not degraded, easy to use the paper again.

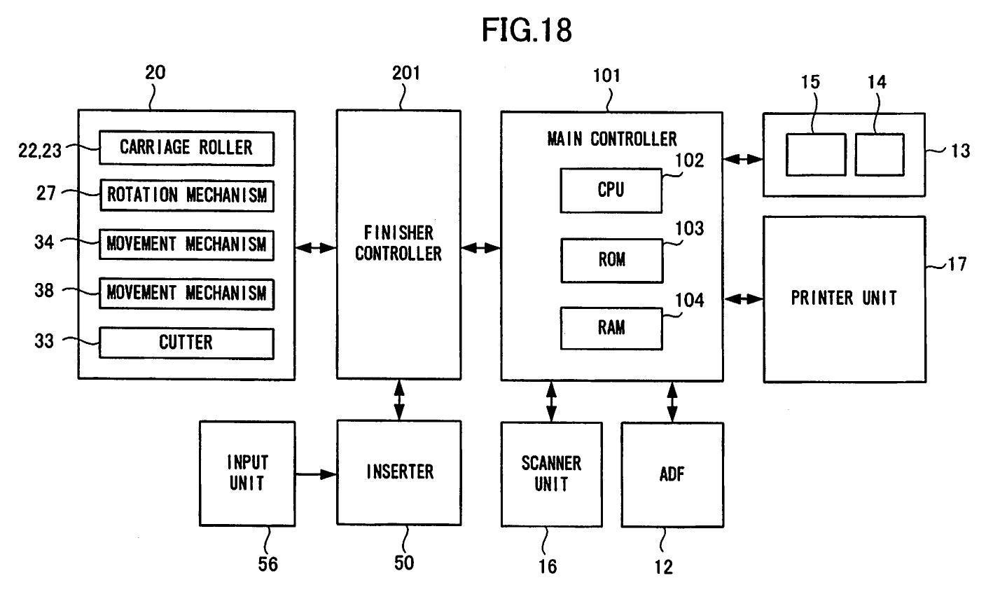

FIG. 18 is a block diagram showing a control system of the finisher 200 and the image forming apparatus 100. In FIG. 18, a main controller 101 includes a CPU 102, a ROM 103 and a RAM 104, and the CPU 102 controls the image forming apparatus 100 in accordance with the control program stored in the ROM 103. The main controller 101 controls the operations of the ADF 12, the scanner unit 16, and the printer unit 17 in response to the operation of the operational panel 13. The RAM 104 temporarily stores control data or is used for a calculation operation during the control.

The operational panel 13 includes the plurality of keys 14 and the display 15 also serving as a touch panel, and can input various instructions for forming an image. For example, the instruction of the number of printing papers is performed by using the keys 14, and the instruction of the paper size, the paper binding, etc. is performed by operating the touch panel of the display

A finisher controller 201 controls the operation of the finisher 200 and the paper discharging operation. The finisher controller 201 is connected to the main controller 101 and the inserter 50, transmits information of the main controller 101 or the inserter 50, and is operated connected with the image forming apparatus 100, the inserter 50, and the finisher 200. The inserter 50 is provided with an input section 56 for inputting the number of inserted papers.

The finisher controller 201 controls the binding unit 20, and controls the rotation of the carriage rollers 22 and 23 so as to carry the paper. In addition, the finisher controller 201 controls the rotation mechanism 27, and controls the rotation of the stopper 25 in accordance with whether the paper is bound or not.

And the finisher controller 201 controls the movement of the holder 31 by controlling the movement mechanism 34, and controls the movement of the pressure roller 35 by controlling the movement mechanism 38. The movement mechanism 34 controls the movement distance of the holder 31 in accordance with the number of bound papers. The movement mechanism 38 sequentially moves the pressure roller 35 in accordance with the number of bound papers, and bends the teeth 411 to 41n of the binding sheet 41 so as to be pressed and attached to the upper surface of each of the papers. In addition, the finisher controller 201 changes the cutting position of the binding sheet 41 in accordance with the number of bound papers by controlling the cutter 33.

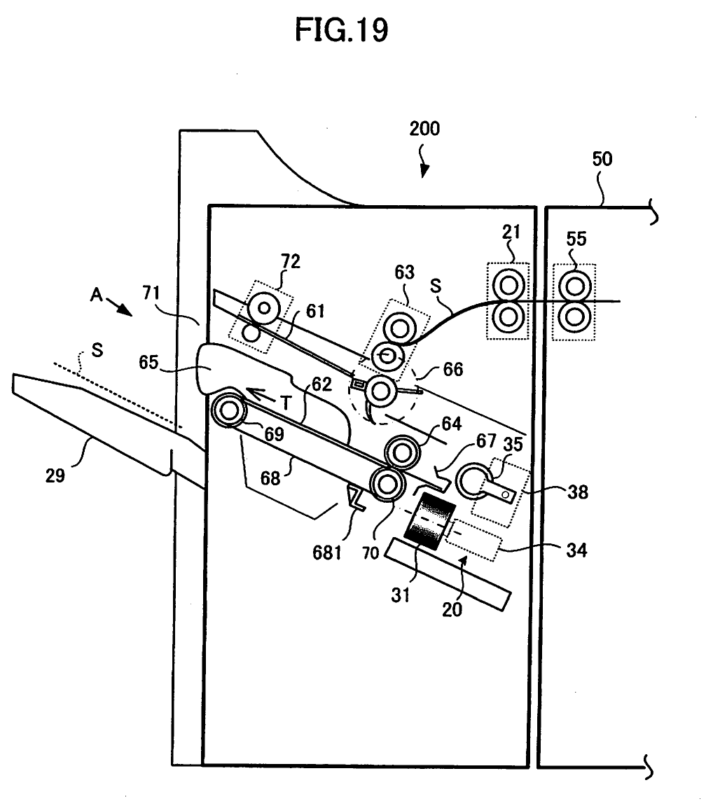

FIG. 19 is a configuration diagram showing a modified example of the finisher 200.

In FIG. 19, the paper S carried from the inserter 50 or the image forming apparatus 100 is carried to the finisher 200 by the carriage roller 55. The finisher 200 includes a standby tray 61, a process tray 62, and the binding unit 20. The paper S carried by the inserter 50 is received by the entrance roller 21 of the finisher 200. The entrance roller 21 includes an upper roller and a lower roller.

A paper feeding roller 63 is provided on the downstream side of the entrance roller 21, and the paper S received by the entrance roller 21 is sent to the standby tray 61 through the paper feeding roller 63. The paper feeding roller 63 includes an upper roller and a lower roller. A process tray 62 is disposed below the standby tray 61 so as to stack the papers S dropped from the standby tray 61.

The standby tray 61 stacks the papers S thereon, and is adapted to be openable and to receive the papers S one by one. The standby tray 61 is opened after receiving the paper S, and the paper S is dropped onto the process tray 62 by its own weight or an operation of a drop assisting member forcibly dropping the paper S.

The paper dropped onto the process tray 62 is sequentially guided to the binding unit 20 by the roller 64. The roller 64 is driven by a motor. The rotation direction of the roller 64 when the paper S is guided to the direction of the binding unit 20 is an opposite direction to that when the bundle of bound papers is discharged.

At the time of the binding process, the papers S dropped from the standby tray 61 onto the process tray 62 are aligned in the longitudinal direction as the carriage direction, and are aligned in the transverse direction perpendicular to the carriage direction. A transverse alignment plate 65 is provided so as to align the papers S in the transverse direction.

In addition, in order to help the paper S to be dropped onto the process tray 62, a rotatable paddle 66 S is provided at a position where the rear end of the paper dropped. The paddle 66 is attached to the rotation shaft, and is used to drop the paper S, dropped from the standby tray 61, onto the process tray 62 and to send the paper S in the direction of the binding unit 20.

The end the process tray 62 on the side of the binding unit 20 is provided with a stopper 67 which regulates the position of the rear end of the paper S. In addition, a carriage belt 68 is provided in order to carry the bundle of bound papers to the storage tray 29. The carriage belt 68 is suspended between pulleys 69 and 70, and the carriage belt 68 is provided with a pawl member 681 which sends the papers S to the carriage belt 68 by pulling the rear end of the papers S.

When the carriage belt 68 rotates in a direction depicted by the arrow T, the papers S are discharged from a discharge opening 71 to the storage tray 29. The storage tray 29 is elevated by a motor so as to receive the papers S. The carriage belt 68 and the pawl member 681 constitute a paper discharge unit which guides the bound papers S to the discharge opening 71.

And when the papers S stacked on the standby tray 61 are discharged onto the storage tray 29 without the binding, the papers S may be discharged to the storage tray 29 by the rotation roller 72 without being dropped onto the process tray 62. The stopper 67 is normally located at the same position, and does not necessarily rotate like the stopper 25 of FIG. 2.

The binding unit 20 includes the holder 31 and the pressure roller 35. The binding unit 20 controls the movement of the holder 31 through the movement mechanism 34, and controls the movement of the pressure roller 35 through the movement mechanism 38. The example of FIG. 19 is different from the configuration of FIG. 1 in that the rear end of the carried paper S is bound and is discharged by the pawl member 681, but has the same basic binding process.

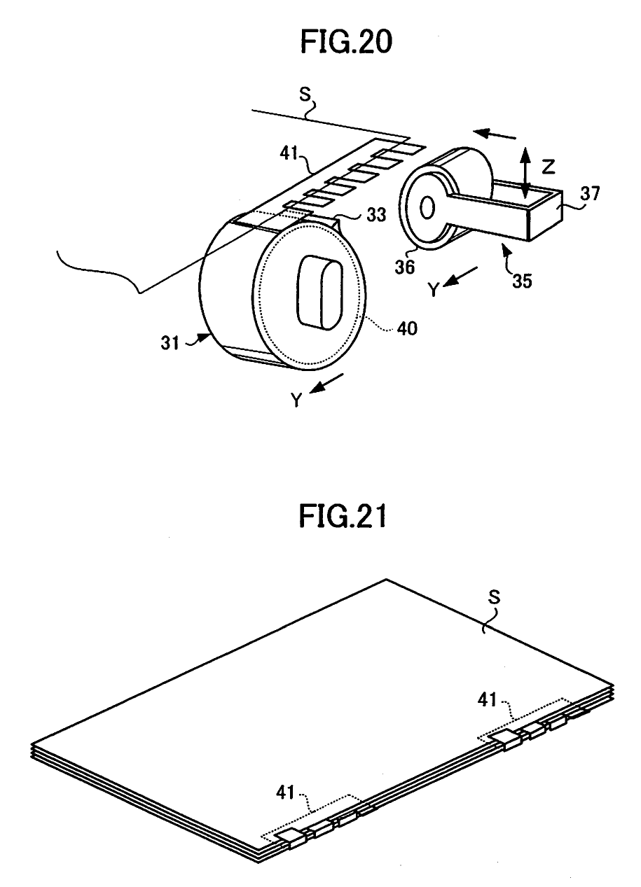

FIG. 20 is a perspective view showing a positional relationship between the pressure roller 35 and the holder 31 of FIG. 19, and the movement directions of the holder 31 and the pressure roller 35 are depicted by the arrow. The movement direction is opposite to that of FIG. 6 in the transverse direction.

FIG. 21 shows an example of a bundle of bound papers. The binding end surfaces of the papers S are opposite to those of FIG. 10.

Next, a second embodiment of the binding unit 20 will be described.

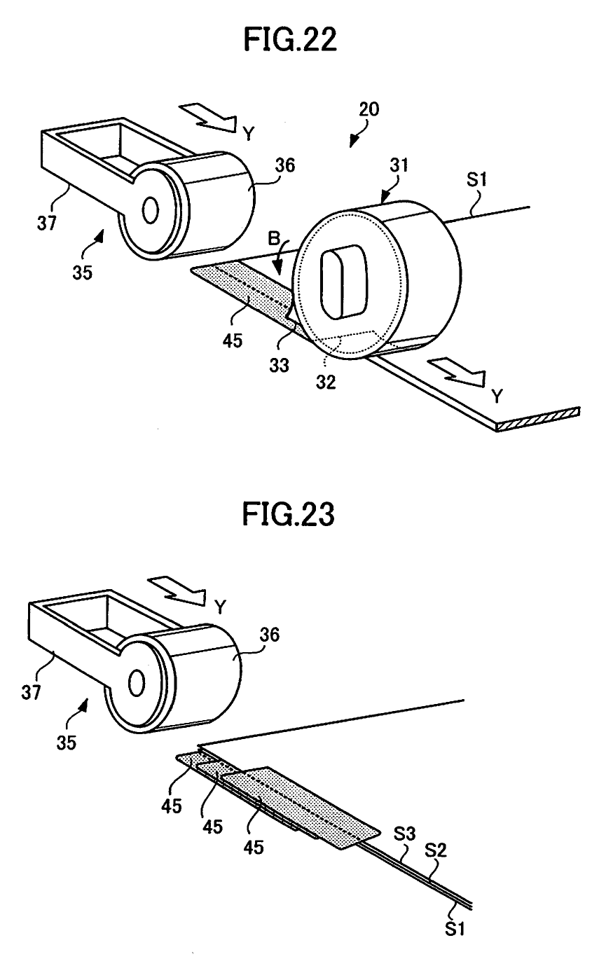

FIG. 22 is a perspective view showing the binding unit 20 performing the binding process through the pressure roller 35 and the holder 31. In the example of FIG. 22, the holder 31 stores a sheet roll obtained by winding a resinous film 45 (hereinafter, referred to as a binding sheet 45) such as polyethylene, polyester, or polypropylene applied with pseudo-adhesive and with flexibility on the rotation shaft 42 (refer to FIG. 5).

The binding sheet 45 is extracted from the outlet 32 provided in the holder 31. In FIG. 22, the outlet 32 is not visible because the outlet 32 is hidden below the holder 31. In addition, pseudo-adhesive is applied to the outer peripheral surface of the binding-sheet 45.

As shown in FIG. 22, the holder 31 is movable in a direction (Y direction) perpendicular to the carriage direction X1 along the front end of the papers, and attaches the binding sheet 45 to the upper surface of the front end of the lowermost paper when the bundle of papers is bound. In addition, the cutter 33 is provided in the outer periphery of the holder 31, and cutter 33 is able to cut the binding sheet 45 at an arbitrary position by rotating the holder 31 in a direction (a direction depicted by the arrow B) coming close to the paper S. In addition, the cutter 33 may be provided separately from the holder 31.

As shown in FIG. 22, when the holder 31 moves in the Y direction while the binding sheet 45 is attached to the upper surface of the paper S, the binding sheet 45 is extracted from the holder 31, and the binding sheet 45 is attached to the paper S. If the holder 31 rotates in the B direction when the binding sheet 45 is extracted by a predetermined length, the binding sheet 45 is cut by the cutter 33. The holder 31 reversely rotates until the original state after the cutting.

The binding sheet 45 has a band shape, and is cut into a predetermined length. Almost half of the binding sheet 45 is attached to the upper-surface of the paper S1, and the other half protrudes from the paper S. The pressure roller 35 includes the roller 36 and the arm 37 supporting the roller 36. The arm 37 is movable in the same direction (Y direction) as that of the holder 31.

As shown 23, when second and third papers S2 and S3 are carried, the holder 31 and the binding sheet 45 are little by little made to be deviated from each other, and the binding sheet 45 is attached to the front end of the paper. In the same manner, the binding sheet 45 is attached in accordance with the number of bound papers. When the binding sheets 45 are attached to all papers, the pressure roller 35 moves in the Y direction while pressing the binding sheet 45 so that the binding sheets 45 are attached to each other.

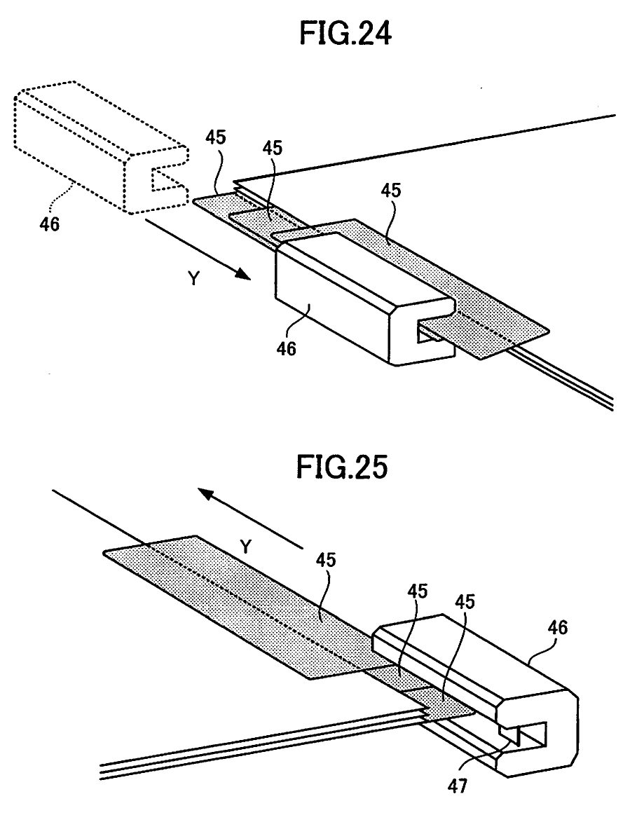

FIG. 24 is a perspective view showing an example in which multiple binding sheets 45 are pressed and attached to each other by the pressure roller 35, and the ends of the films are heat-welded to each other by the thermal, head 46.

After the binding sheets 45 are pressed and attached to each other by the pressure roller 35, the holder 31 and the pressure roller 35 first move to the withdrawal position, and the thermal head 46 moves in the Y direction along the front end of the paper S so as to weld the binding sheets 45 and to integrate the stacked papers S.

In addition, as shown in FIG. 25, a cutter 47 is provided inside the thermal head 46. FIG. 25 is a perspective view of the thermal head 46 when seen in a direction different from FIG. 24. The end of the welding portion of the film is cut by the cutter 47 when the thermal head 46 moves. Since the end of the film welding portion is cut, possible to prevent the user contact portion from being uneven, and to prevent fingers from being hurt.

The binding process of the papers may be performed at two positions of the front end of the bundle of papers as in FIG. 10. Alternatively, three or more positions may be bound, or one position may be lengthily bound. When the bundle of bound papers is unfolded about the binding sheet 45, each of the papers can be easily unfolded without bending. The unfolding angle may be close to 360°. Further, possible to obtain a bundle of papers without damaging the front surface or the rear surface of the paper S and the end of the paper S, the quality of the paper is not degraded.

In addition, after the bundle of papers is obtained by the binding sheet 45 and the binding sheet 45 is pulled, the paper can be peeled without damaging the paper. Further, since the attachment positions of the binding sheets 45 are deviated from each other as shown in FIG. 23, the binding sheets can be easily peeled, and the bundle of papers can be easily separated, accordingly, easy to reuse the paper. In addition, since the attachment positions of the binding sheets 45 are deviated from each other, possible to suppress an increase in thickness of the film, and to prevent a peeling force from concentrating on a part when the film is peeled.

Further, not limited to the above-described embodiments, and can be modified into various forms. For example, an example is described in which the binding unit 20 is provided inside the finisher 200, but the binding unit 20 may be attached to the inside of the image forming apparatus 100. In addition, a single binding apparatus may be configured by integrating the binding unit 20 and the inserter 50.

While certain embodiments have been described, these embodiments have been, presented by way of example only, and are not intended to limit the scope of the invention. Indeed, the novel apparatus and methods described herein may be embodied in a variety of other forms; furthermore, various omissions, substitutions and changes in the form of the apparatus and methods described herein may be made without departing from the spirit of the inventions. The accompanying claims and their equivalents are intended to cover such forms or modifications as would fall within the scope and spirit of the inventions.

What is claimed is:

1. A paper binding apparatus comprising:
a paper carrying unit which carries papers so as to be sequentially stacked on a tray;
a binding sheet supply unit which attaches a binding sheet applied with pseudo-adhesive to a lower surface of one end of the paper first stacked on the tray in the carriage direction so as to protrude in a pectinate shape;
a binding sheet attaching unit which sequentially bends a plurality of protruding pieces of the binding sheet so as to be pressed against an upper surface of one end of the carried paper whenever a new paper is carried to the tray; and
a discharge unit which discharges a bundle of papers bound by the binding sheet.

2. The apparatus of claim 1,
wherein the binding sheet supply unit includes a sheet roll in which a pectinate-shaped binding sheet having a plurality of pectinate-shaped protruding pieces is wound in a roll shape, and a cutter which sets the number of protruding pieces of the binding sheet in accordance with the number of bound papers and cuts the binding sheet at the set position, and attaches the binding sheet cut by the cutter to the first stacked paper.

3. The apparatus of claim 1,
wherein the binding sheet attaching unit includes a pressure roller which bends the protruding piece of the binding sheet from one end of the paper in the upward direction and bends the protruding piece in the reverse direction of the carriage direction of the paper so as to be pressed against an upper surface of the paper.

4. The apparatus of claim 3,
wherein the binding sheet attaching unit sequentially moves the pressure roller in accordance with the number of the carried papers in a direction perpendicular to the carriage direction, and bends the corresponding protruding piece of the binding sheet to be attached to the upper surface of each paper.

5. The apparatus of claim 1,
wherein the binding sheet attaching unit bends the protruding piece at a position spaced from one end of the paper by a predetermined gap so as to be attached to an upper surface of the paper.

6. The apparatus of claim 1,
wherein the binding sheet includes the plurality of protruding pieces extending from a sheet body in a pectinate shape, and a root portion of each of the plurality of protruding pieces is round.

7. The apparatus of claim 1,
wherein the binding sheet includes a non-application area of the pseudo-adhesive provided in a part of the plurality of protruding pieces.

8. The apparatus of claim 1,
wherein the binding sheet has a mark which indicates a peeling direction when the binding sheet is pulled and peeled off from the paper.

9. A paper binding apparatus comprising:
a paper carrying unit which carries papers so as to be sequentially stacked on a tray;
a binding sheet supply unit which attaches a binding sheet applied with pseudo-adhesive to one end portion of the paper sequentially stacked on the tray in the carriage direction so as to protrude, and attaches the binding sheet by deviating a position thereof whenever the paper is carried;
a binding sheet attaching unit which presses the one end portion of the paper attached with the binding sheet so as to weld the binding sheet; and
a discharge unit which discharges a bundle of papers bound by the binding sheet.

10. The apparatus of claim 9,
wherein the binding sheet supply unit includes a sheet roll in which a band-shaped binding sheet is wound in a roll shape, and a cutter which cuts the binding sheet into a predetermined length in advance, and attaches the cut binding sheet to one end of the sequentially carried paper.

11. The apparatus of claim 9,
wherein the binding sheet attaching unit includes a pressure roller which presses the one end of the paper attached with the binding sheet, and a thermal head which welds the pressed binding sheet.

12. The apparatus of claim 11,
wherein the thermal head includes a cutter which cuts the end of the welded binding sheet.

13. A paper binding method comprising:
carrying papers so as to be sequentially stacked on a tray;
attaching a binding sheet applied with pseudo-adhesive to a lower surface of one end of the paper first stacked on the tray in the carriage direction so as to protrude in a pectinate shape;
sequentially bending a plurality of protruding pieces of the binding sheet so as to be pressed and attached to an upper surface of one end of the carried paper whenever a new paper is carried to the tray; and
discharging a bundle of papers bound by the binding sheet.

14. The method of claim 13,
wherein the pectinate-shaped binding sheet having the plurality of pectinate-shaped protruding pieces is wound in a roll shape,
the number of protruding pieces of the binding sheet is set in accordance with the number of the bound papers, and
the binding sheet is cut at the set position, and the cut binding sheet is attached to the first stacked paper.

15. The method of claim 13,
wherein a pressure roller bends the protruding piece of the binding sheet from one end of the paper in the upward direction and bends the protruding piece in the reverse direction of the carriage direction of the paper so as to be pressed against an upper surface of the paper, and
the pressure roller sequentially moves in accordance with the number of the carried papers in a direction perpendicular to the carriage direction, and the corresponding protruding piece of the binding sheet is bent to be attached to the upper surface of each paper.

16. The method of claim 13,
wherein the protruding piece of the binding sheet is bent at a position spaced from one end of the paper by a predetermined gap so as to be attached to an upper surface of the paper.

17. A paper binding method comprising:
carrying papers so as to be sequentially stacked on a tray;
attaching a binding sheet applied with pseudo-adhesive to one end of each of the papers sequentially stacked on the tray in the carriage direction so as to protrude, and attaching the binding sheet by deviating a position thereof whenever the papers are carried;
pressing the one end of the paper attached with the binding sheet so as to weld the binding sheet; and
discharging a bundle of papers bound by the binding sheet.

18. The method of claim 17,
wherein the band-shaped binding sheet is wound in a roll shape, and
the binding sheet is cut into a predetermined length, and is attached to one end of the sequentially carried paper.

19. The method of claim 17,
wherein the one end of the paper attached with the binding sheet is pressed by a pressure roller, and
the pressed binding sheet is welded by a thermal head.

20. The method of claim 19,
wherein the thermal head includes a cutter, and cuts the end of the welded binding sheet.

21. An image forming apparatus comprising:
an image forming unit which forms an image on a paper;
a paper carrying unit which carries the paper from the image forming unit so as to be sequentially stacked on a tray;
a binding sheet supply unit which attaches a binding sheet applied, with pseudo-adhesive to a lower surface of one end of the paper first stacked on the tray in the carriage direction so as to protrude in a pectinate shape;
a binding sheet attaching unit which sequentially bends a plurality of protruding pieces of the binding sheet so as to be pressed against an upper surface of one end of the carried paper whenever a new paper is carried to the tray;
a discharge unit which discharges a bundle of papers bound by the binding sheet; and
a storage tray which receives a bundle of papers discharged from the discharge unit.

22. The apparatus of claim 21,
wherein the binding sheet supply unit includes a sheet roll in which a pectinate-shaped binding sheet having a plurality of pectinate-shaped protruding pieces is wound in a roll shape, and a cutter which sets the number of protruding pieces of the binding sheet in accordance with the number of bound papers and cuts the binding sheet at the set position, and attaches the binding sheet cut by the cutter to the first stacked paper.

23. The apparatus of claim 21,
wherein the binding sheet attaching unit includes a pressure roller which bends the protruding piece of the binding sheet from one-end of the paper in the upward direction and bends the protruding piece in the reverse direction of the carriage direction of the paper so as to be pressed against an upper surface of the paper.

24. The apparatus of claim 23,
wherein the binding sheet attaching unit sequentially moves the pressure roller in accordance with the number of the carried papers in a direction perpendicular to the carriage direction, and bends the corresponding protruding piece of the binding sheet to be attached to the upper surface of each paper.

25. The apparatus of claim 21,
wherein the binding sheet attaching unit bends the protruding piece at a position spaced from one end of the paper by a predetermined gap so as to be attached to an upper surface of the paper.

26. An image forming apparatus comprising:
an image forming unit which forms an image on a paper;
a paper carrying unit which carries the paper from the image forming unit so as to be sequentially stacked on a tray;
a binding sheet supply unit which attaches a binding sheet applied with pseudo-adhesive to one end of the paper sequentially stacked on the tray in the carriage direction so as to protrude, and attaches the binding sheet by deviating a position thereof whenever the paper is carried;
a binding sheet attaching unit which presses the one end of the paper attached with the binding sheet so as to weld the binding sheet;
a discharge unit which discharges a bundle of papers bound by the binding sheet; and
a storage tray which receives a bundle of papers discharged from the discharge unit.

27. The apparatus of claim 26,
wherein the binding sheet supply unit includes a sheet roll in which a band-shaped binding sheet is wound in a roll shape, and a cutter which cuts the binding sheet into a predetermined length in advance, and attaches the cut binding sheet to one end of the sequentially carried paper.

28. The apparatus of claim 26,
wherein the binding sheet attaching unit includes a pressure roller which presses the one end of the paper attached with the binding sheet, and a thermal head which welds the pressed binding sheet.

29. The apparatus of claim 28,
wherein the thermal head includes a cutter which cuts the end of the welded binding sheet.
